(19) United States
(12) Patent Application Publication
(10) Pub. No.: US 2026/0102919 A1
(43) Pub. Date: Apr. 16, 2026

(54) SYSTEMS AND METHODS FOR CAPTURING IMAGES USING ROBOTIC AGENT

(71) Applicant: Capital One Services, LLC, McLean, VA (US)

(72) Inventors: Debashish ROY, Bangalore (IN); Amrit Presanna KUMAR, Bangalore (IN); Anuj CHAUDHARY, Bangalore (IN); Dontula KARTHIK, Bangalore (IN)

(73) Assignee: Capital One Services, LLC, McLean, VA (US)

(21) Appl. No.: 18/912,136

(22) Filed: Oct. 10, 2024

(51) Int. Cl. B25J 9/16; G06V 10/44; G06V 10/764

(52) U.S. Cl. CPC B25J 9/1697; B25J 9/1664; G06V 10/44; G06V 10/764

(57) ABSTRACT

A method includes capturing, by a camera in a robotic system, a first image of an object at a first location. The method also includes, identifying, by a processor in the robotic system, whether one or more features are present in the first image of the object using an object detection model. In response to determining that at least one feature of the one or more features are present in the first image of the object, the method further includes instructing, by the processor, a robotic agent to move based on a class of the at least one feature that is present in the first image. The method may also include capturing, by the camera, a second image of the object at a second location.

### BACKGROUND

E-commerce websites often display images of inventory. To ensure quality and uniformity, these images are often captured by a professional photographer. Professional photography services, however, are costly, time consuming, and do not scale well when large amounts of inventory need to be photographed.

### BRIEF DESCRIPTION OF THE DRAWINGS

The accompanying drawings are incorporated herein and form a part of the specification.

FIG. 1 shows a robotic system, according to an embodiment.

FIG. 2 shows a flow diagram of a process for automatically capturing images of an object, according to an embodiment.

FIG. 3 shows a flow diagram of a process for sending movement instructions to a robotic agent, according to an embodiment.

FIGS. 4A, 4B, 4C, 4D, and 4E show environments for capturing 360° images of an object, according to an embodiment.

FIG. 5 shows a system for capturing 360° images of an object, according to an embodiment.

FIG. 6 shows a process for moving a robotic system, according to an embodiment.

FIG. 7 shows a process for capturing images, according to an embodiment.

FIG. 8 shows an example computer system, according to an embodiment.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for capturing images of an object, such as a vehicle, using a robotic system.

Many fields, such as e-commerce and quality control, often require images to meet certain guidelines or specifications. These guidelines may include specific standards for image quality, angle, lighting, and background. In the case of the e-commerce field, online marketplace managers may require images to follow certain conventions to provide a cohesive user experience and present products in a uniform and professional manner. To obtain uniform, quality images, many online marketplace mangers hire professional photographers.

Some e-commerce marketplaces require images of a large variety of products. For example, a used car dealership may require uniform images of every vehicle sold. In this scenario, it may be costly and time consuming to hire a professional photographer to photograph tens or hundreds or thousands of unique vehicles.

The technology described in the various embodiments herein implements an automatic image capture system for producing images in a standardized format. In some embodiments, a robotic system automatically captures 360° images of a vehicle in a standardized, reproducible format. A camera in the robotic system may capture an image of the vehicle at a first location. Then, a processor in the robotic system may analyze the image to identify and classify one or more features present in the image. The processor may then use one or more classes of the one or more features to determine movement instructions for the robotic system. For example, if the classes of identified features indicate that the robotic system is located at a corner of the vehicle, the processor may instruct the robotic system to rotate. Alternatively, if the classes of identified features indicate that the robotic system is located along a side of the vehicle, the processor may instruct the robotic system to move in a straight line, parallel to the side of the vehicle. Once the robotic system has moved to a new location, the robotic system may capture a second image of the vehicle. These steps may be repeated until images of all sides (e.g., driver's side, rear, passenger's side, front) of the vehicle have been captured.

In some embodiments, a robotic system maintains a uniform distance from a vehicle during image capture. A distance sensor attached to or integrated into the robotic system may measure the distance between the robotic system and the vehicle. A processor in the robotic system may receive distance measurements from the sensor and generate movement instructions that maintain a uniform distance between the robotic system and vehicle.

A skilled artisan would understand that images of an object other than a vehicle (e.g., furniture, home goods, toys, watercraft, etc.) may be captured using the techniques disclosed herein.

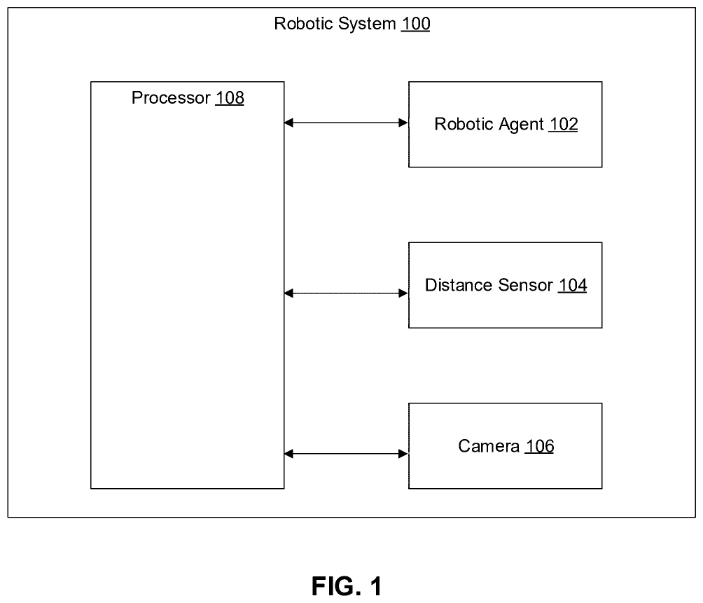

FIG. 1 shows a robotic system 100, according to some aspects. Robotic system 100 can include a robotic agent 102, a distance sensor 104, a camera 106, and a processor 108. The robotic system may further include a user interface including, for example, a display and one or more user input devices (e.g., touchscreen, keyboard, etc.) for accepting user input and providing information to the user (e.g., visual, aural, tactile, etc.).

In some aspects, robotic agent 102 may comprise a ground robot, an unmanned aerial vehicle (such as a drone), or the like. A ground robot may contain wheels or tracks that allow the robot to move throughout an environment. Robotic agent 102 may be configured to move and rotate in any direction in response to movement instructions received from processor 108. In one embodiment, wherein robotic agent 102 comprises a ground robot, the movement instructions may indicate an amount of force that one or more motors apply to each wheel of the robotic agent. In another embodiment, when the robotic agent comprises an unmanned aerial vehicle, the movement instruction may indicate an amount of force that one or more motors apply to the each propeller of the robotic agent.

Distance sensor 104 may be attached to or integrated into (e.g., contained within same housing as) robotic agent 102. Distance sensor 104 may comprise an ultrasonic sensor, a LIDAR sensor, an infrared (IR) sensor, or the like. As robotic agent 102 moves in an environment, distance sensor 104 may collect data. The data may be sent to processor 108, which may process the data (i.e., determine distance between the robotic agent and an object). In an alternative embodiment, distance sensor 104 may contain a second processor capable of processing the data before it is sent to processor 108. In some aspects, processor 108 may track distance measurements to ensure that the robotic agent maintains an approximately constant distance from an object.

Camera 106 may be attached to or integrated into (e.g., contained with same housing as) robotic agent 102. Camera 106 may be configured to capture still images and/or video of an object as robotic agent 102 moves throughout an environment. Camera 106 may be configured to capture a video or a series of individual frames at predefined intervals (e.g., 30 frames per second). The images and/or video captured by camera 106 may be sent to processor 108. Images and video may be detected by an active-pixel sensor (such as a complementary metal-oxide-semiconductor (CMOS) image sensor or a charge-coupled device (CCD). In a CCD, for example, there is a photoactive region (an epitaxial layer of silicon), and a transmission region made out of a shift register. An image is first projected through a lens onto the photoactive region of the CCD, causing each capacitor of a capacitor array to accumulate an electric charge proportional to the light intensity at that location. A one-dimensional array, used in line-scan cameras, captures a single slice of the image, whereas a two-dimensional array, used in video and still cameras, captures a two-dimensional picture corresponding to the scene projected onto the focal plane of the sensor. Once the array has been exposed to the image, a control circuit causes each capacitor to transfer its contents to its neighbor (operating as a shift register). The last capacitor in the array dumps its charge into a charge amplifier, which converts the charge into a voltage. By repeating this process, the controlling circuit converts the entire contents of the array in the semiconductor to a sequence of voltages. These voltages are then sampled, digitized, and may be stored in computer memory within camera and/or device that incorporates a camera (such as a smart phone). In some embodiments, the camera may pan, zoom, and/or tilt such that the camera may capture images of the object in a variety of ways.

In some embodiments, the functionalities of both camera 106 and distance sensor 104 may be integrated into a single device. For example, some smart phones incorporate both a camera and distance sensor into a single device. In some embodiments, the robotic system 100 may comprise a smart phone coupled to a robotic agent 102.

Processor 108 may process image data captured by camera 104 in real time. For example, processor 108 may extract an image frame from a video captured by camera 104. The processor may use an object detection model to identify and classify one or more features in the image frame. Then, processor 108 may determine, based on the class of feature, movement instructions for robotic agent 102. The processor may extract and process image frames from the video at a predefined interval (e.g., 0.1 second, 0.5 second, 1 second etc.).

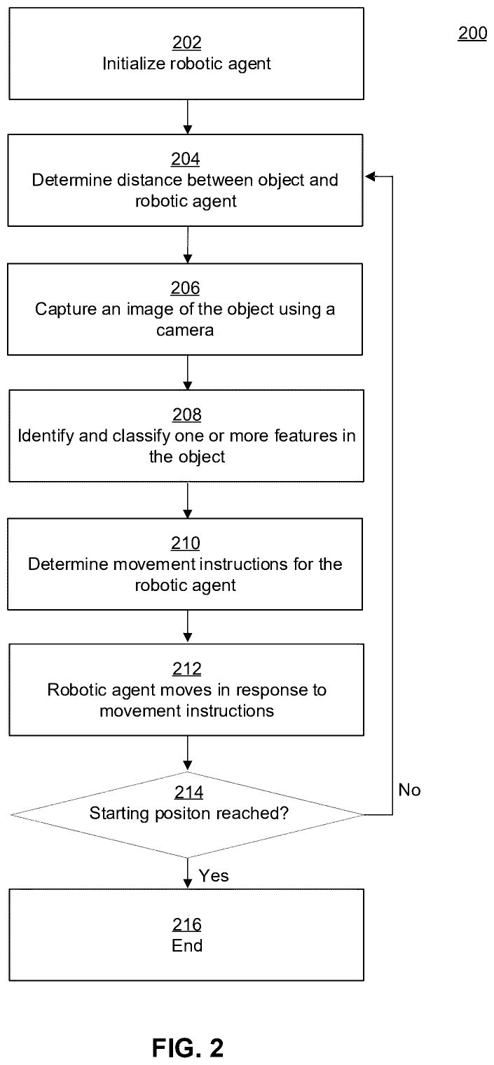

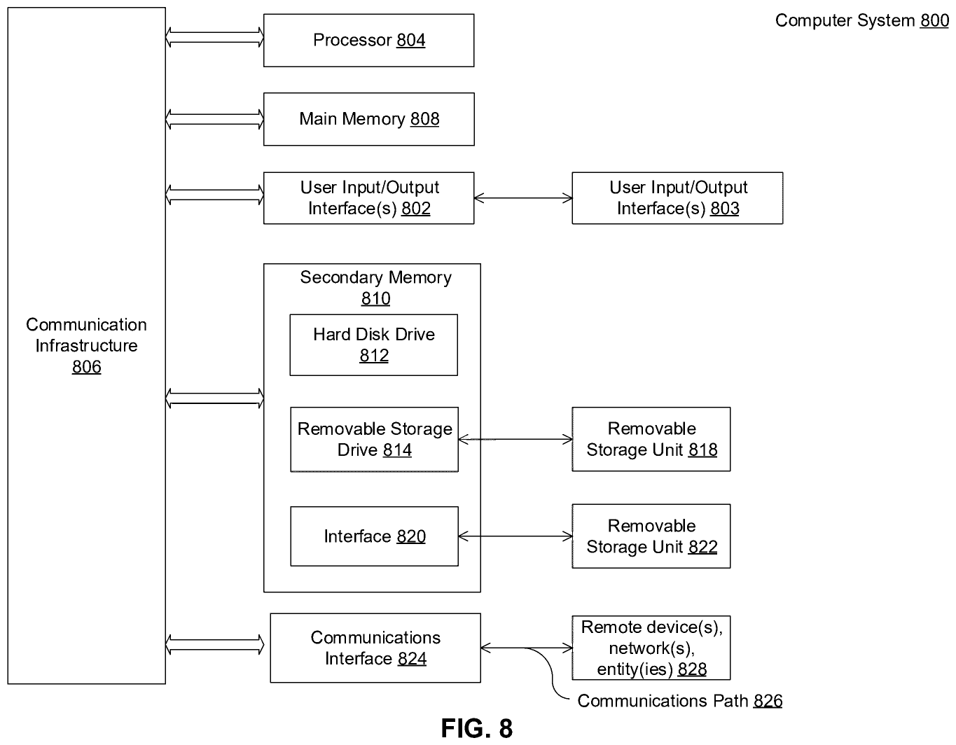

FIG. 2 shows a flow diagram of a process 200 for capturing 360° images of an object, such as a vehicle, according to some embodiments. Process 200 may be used to automatically capture images of an object by a robotic system, such as robotic system 100 of FIG. 1. It may be appreciated that not all steps may be needed to perform the disclosure provided herein. Furthermore, some of the steps can be performed simultaneously, or in a different order than the one shown in FIG. 2, as will be understood by a person of ordinary skill in the art. The steps of process 200 may be implemented by one or more computer systems, such as computer system 800 described in FIG. 8. The process 200 can also be implemented as instructions stored on a machine-readable medium, which can be read and executed by one or more processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others.

At step 202, the system may receive initialization instructions from a user, such as via a user interface on a smart phone or the like. Initialization instructions may set operating variables, such as a velocity, direction of movement, and direction of rotation of a robotic system. Initialization instructions may also set parameters or thresholds related to movement instructions, such as a predefined or predetermined interval wherein the robotic system is prevented from rotating. Furthermore, initialization instructions may contain initial values for key variables, such as a time variable that tracks the amount of time since the last rotation, which may initially be set to zero.

At step 204, a processor of the system may determine a distance between an object and a robotic agent using data collected by a distance sensor. The distance sensor may comprise, for example, an ultrasonic sensor, a LiDAR sensor, a time-of-flight sensor, or the like. Alternatively, the distance sensor my determine the distance and transmit the determined distance to the processor.

At step 206, a camera of the system may capture an image of the object. The image may comprise a frame of a video (such as a video that is captured at 30 frames/second or at 60 frames/second). The image may comprise a still image. The image or frame or video captured by the camera may be sent to the one or more computer systems.

At step 208, the processor of the system may identify whether one or more features are present in the first image using an object detection model. The object detection model may comprise a neural network or the like that is configured to identify and classify features in an image. For example, the object detection model may identify classes of vehicle features, such as headlights, taillights, windows, door handles, and mirrors.

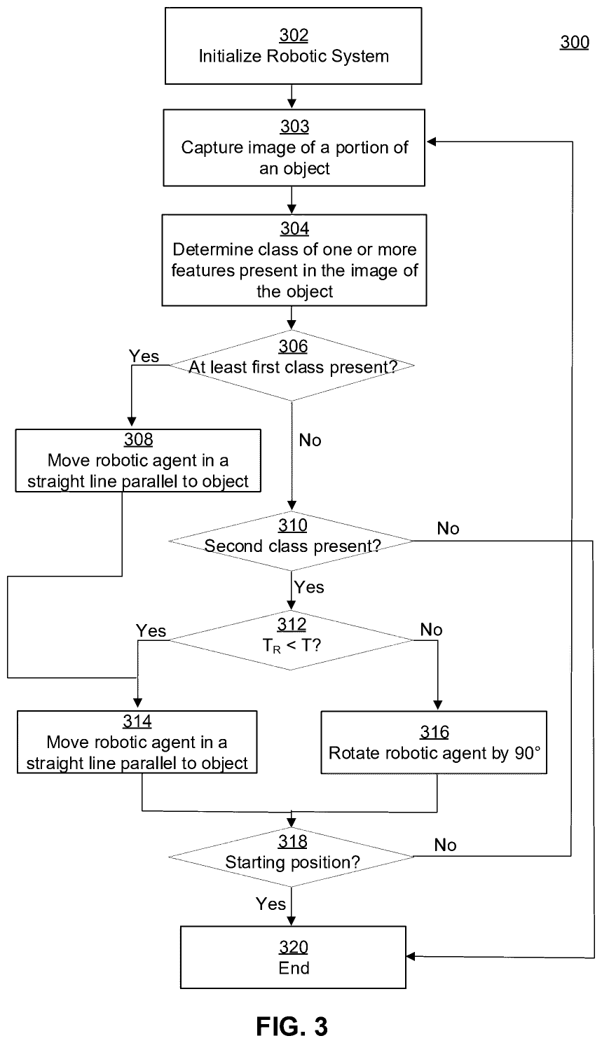

At step 210, in response to identifying one or more features in step 208, the processor of the system may determine movement instructions for the robotic agent based on the class of the one or more features identified at step 208. Movement instructions may direct the robotic system to move in a straight line parallel to the object and/or to rotate to capture another side of the object. More information on movement instructions are given below in FIG. 3.

At step 212, the robotic agent may move in response to the movement instructions sent by the processor.

At step 214, the system may determine if the robotic agent has returned to its starting position. If the robotic agent has returned to its starting position, process 200 may end at step 216. Otherwise, process 200 may return to step 204 and repeat steps 204-214 one or more times until the robotic agent has returned to its starting position.

FIG. 3 shows a flow diagram of a process 300 for automatically moving a robotic agent around an object, such as a vehicle, according to some embodiments. Process 300 may be used in conjunction with the robotic system 100 of FIG. 1 and the process 200 of FIG. 2. It may be appreciated that not all steps may be needed to perform the disclosure provided herein. Furthermore, some of the steps can be performed simultaneously, or in a different order than the one shown in FIG. 3, as will be understood by a person of ordinary skill in the art.

In some embodiments, process 300 describes a process for determining movement instructions for a robotic agent. The movement instructions may instruct the robotic agent to move around a perimeter of an object, such as a vehicle, and may comprise a series of linear movements and rotations. While the movements are described herein as linear, a person of ordinary skill in the art would recognize that other movements, such as circular movement around an object or elliptical movement around an object, are within the scope of this disclosure. The steps of process 300 may be implemented by one or more computer systems, such as computer system 800 described in FIG. 8. The process 300 can also be implemented as instructions stored on a machine-readable medium, which can be read and executed by one or more processors.

At step 302, the system may receive initialization instructions from a user, such as via a user interface on a smart phone or the like. Initialization instructions may set operating variables, such as a velocity, direction of movement, and direction of rotation of a robotic system. Initialization instructions may also set parameters related to movement instructions, such as a predefined interval wherein the robotic system is prevented from rotating. Furthermore, initialization instructions may contain initial values for key variables, such as time since last rotation, which may be set to zero.

At step 303, the system may capture a new image of an object. The image may be captured by a camera in the robotic system such as camera 106 described in FIG. 1.

At step 304, the system may determine one or more classes of one or more features present in an image of an object using, for example, an object detection and classification model. The image may be captured by a camera, such as described in step 206 of the process 200 of FIG. 2.

The object detection and classification model may first detect features present in an image. For a vehicle, features may include: door handles, doors, fenders (front and/or back), side windows, windshields (front and/or back), hubcaps, headlights and taillights, bumpers (front and/or back), license plates (front and/or back), etc. Then, the object detection and classification model may group the detected features into at least two classes. The classes may be based on where a feature is located in an object or based on other criteria, as would be apparent to those skilled in the art. For example, a first class of features may comprise features that are present in a middle portion of an object, while a second class of features may comprise features that are present near the edges of an object. If the object is a vehicle, the first class of features may include features that are present in a middle section of the vehicle, such as license plates, door handles, doors, side windows, back and front windshields, etc. The second class of features may include features that are present at the edges (e.g., corners) of the vehicle, such as headlights, taillights, hubcaps, etc.

At step 306, the system may determine if at least the first class of features is present, such as side windows of a vehicle. Detecting the first class of features may indicate that the robotic system is located along a side of the object. In some embodiments, if the camera of the robotic system has a wider field of view, both the first and second classes of features may be detected simultaneously.

If at least a feature in the first class of features is present (e.g., a side window is present in the image), process 300 may move to step 308, where the processor instructs the robotic agent to move in a straight line, approximately parallel to a side of the object. A distance sensor in the robotic system may measure the distance between the robotic system and the object to ensure that the robotic agent moves approximately parallel to the object. For example, if the distance between the robotic system and the object changes, the system may alter the movement instructions sent to the robotic agent.

If a feature in the first class of features is not present, process 300 may move to step 310. At step 310, the processor may determine if the second class of feature is present in the image of the object. If neither a first class nor second class of feature is present, process 300 may end. Furthermore, a user may manually intervene (e.g., stop the process or reposition the robotic agent) if neither a first nor second class of feature is present. Once repositioned manually, process 300 may be restarted.

Detection of a feature in the second class of features (e.g., a headlight or a taillight), but not a feature in the first class of features (e.g., side window), may indicate that the robotic agent has reached the boundary of a side of the object and needs to rotate to capture a new side of the object. However, once the robotic agent rotates, the subsequent captured image may still only capture the second class of feature. Without additional instructions, this would cause the robotic agent to rotate a second time. A second rotation, however, may cause the robotic agent to face away from the object, which is undesirable (e.g., when the robotic agent does not face the object, it does not capture images of the object). To ensure that the robotic agent only rotates once at each corner of an object, a time variable may be introduced. The time variable may keep track of the time since last rotation and may be reset after each rotation. As described in step 202 of the method 200 of FIG. 2, the initial value of the time variable may be set to zero.

At step 312, value of the time variable may be compared to the predefined or predetermined amount of time (e.g., a time threshold or a rotation threshold).

In some embodiments, the predefined or predetermined amount of time can be defined as T=W/2v, where W is the width of an object and v is the velocity of the robotic system. The predefined time may be calculated before the robotic system is initialized. The time (T) may be computed upon initialization and may be considered a threshold time before which the robotic agent may not be instructed to rotate 90 degrees.

If the time since the previous rotation (T_{R}) is less than the predefined time (T), the processor may instruct the robotic agent to move in a straight line parallel to the object at step 314. Alternatively, if the time since the last rotation is greater than the predefined time, the processor may instruct the object to rotate 90° at step 316.

After a movement at step 308, 314, or 316, the processor may determine if the robotic system has returned to its starting position at step 318. If the robotic agent has returned to its starting position, process 300 ends at step 320. Otherwise process 300 returns to step 303.

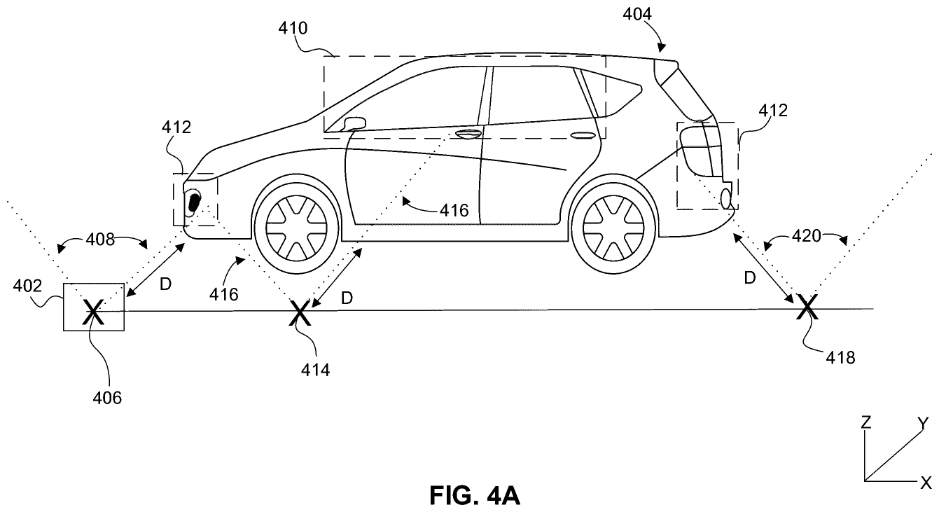

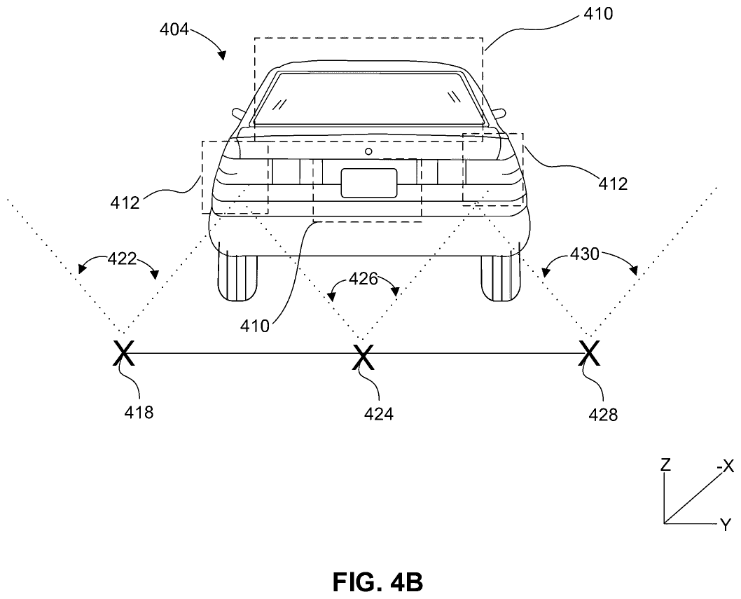

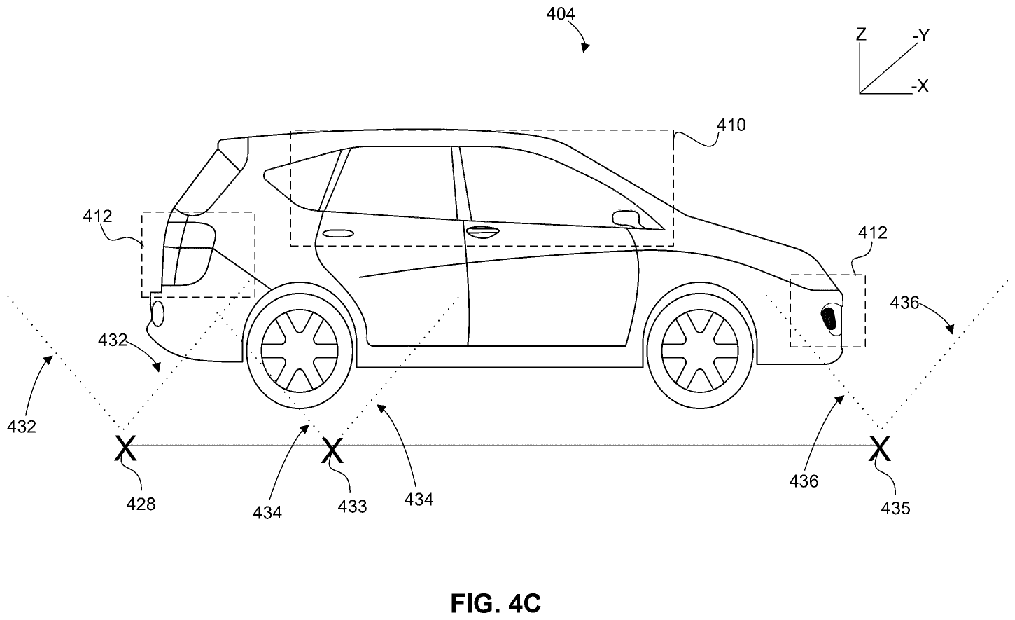

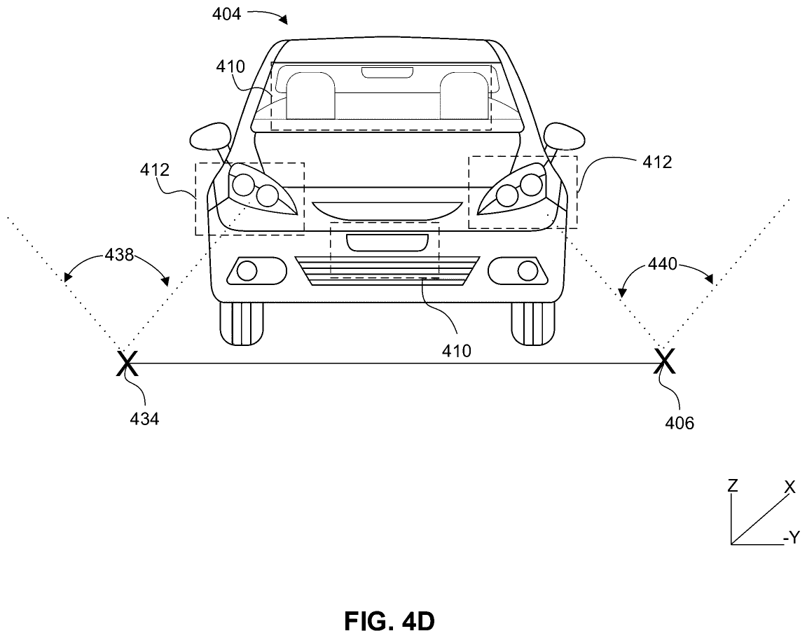

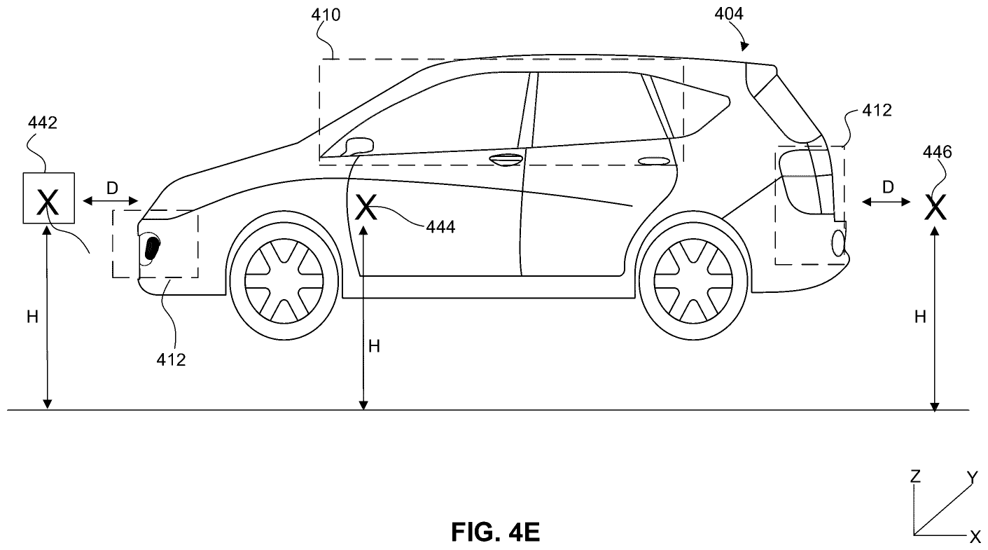

FIG. 4A shows a schematic of example movements of a robotic system 402 along a first side of a vehicle 404, according to some embodiments. Robotic system 402 may contain a ground robotic agent capable of moving in any direction and rotating. Robotic system 402 may be the robotic system described with respect to FIG. 1. As described in FIGS. 2 and 3, the processor may instruct the robotic agent to move based on images captured by the camera.

In some aspects, robotic system 402 may be initialized at a first position 406. In the example shown in FIG. 4A, first position 406 is located near the headlights of the driver's side of the vehicle 404. First position 406 may be a distance D away from vehicle 404. During initialization, a user may position the robotic agent near the vehicle, such that a camera attached/integrated into robotic system 402 is facing the vehicle. The user may also initialize variables and/or set initial movement instructions for the robotic system 402. For example, a time since previous rotation (T_{R}), as described in reference to step 312 in FIG. 3, may be set to zero. Furthermore, a user can set an initial velocity for the robotic system and a predefined time, which may limit the time between rotations of robotic system 402. As described above, the predefined time may equalT=W/2v, where W is the width vehicle 404 (as defined below in FIG. 4B) and v is the velocity of the robotic system.

At first position 406, the camera may capture an image of the portion of object 404 traced by rays 408. The processor in robotic system 402 may receive the image and determine classes of features present in the image using an object detection model.

In the example shown in FIG. 4A, only a second class of feature 412 (e.g., headlights) is present in the image captured at first position 406. Because T_{R} was set to zero at initialization, the time since last rotation is less than the predefined time, the processor instructs the robotic agent to move in a straight line in the +X direction (as indicated in FIG. 4A) towards second position 414. In this example, the robotic agent moves from a position at the front, driver's side of the vehicle in a straight line approximately parallel to the vehicle toward the rear of the vehicle.

At second position 414, robotic system 402 may capture another image of vehicle 404. The image may capture the portion of vehicle 404 traced by rays 416. This image contains both a feature in the first class of features 410 (e.g., one or more side windows) and a feature in the second class of features 412 (e.g., driver's side headlight). As described in reference to FIG. 3, the processor may instruct the robotic agent to move in a straight line when at least the first class of feature 410 is present. Thus, robotic system 402 moves in a straight line approximately parallel to the vehicle in the +X direction towards third position 418 at the rear, drivers side of the vehicle.

The robotic system may reach third position 418 just past the end of the first side of vehicle 404 (e.g., driver's side, just past taillights). At third position 418, the camera of robotic system 402 may capture the portion of vehicle 404 traced by rays 420. This image may contain only a feature in the second class of feature 412 (e.g., driver's side taillight). To determine movement instructions, the processor may check if the time since last rotation is greater than the predetermined amount of time. In the example, shown in FIG. 4A, enough time has elapsed (e.g., the robotic system has traveled a distance greater than half the width of vehicle 404), and robotic system 402 may rotate counterclockwise. After the rotation, the camera in robotic system 402 may face a second side of vehicle 404 (i.e., the back end of vehicle 404), as shown in FIG. 4B.

FIG. 4B shows a schematic of movements of robotic system 402 along a second side (rear) of vehicle 404. After the rotation, the camera may capture an image of the second side of vehicle 404 at third position 418. At this location, the resulting image, traced by rays 422, may only contain a feature in the second class of features 412 (e.g., taillight). However, because the robotic system has just rotated, the time since the last rotation is less the predefined amount of time, robotic agent 402 will move in a straight line in the +Y direction (as shown in FIG. 4B) towards fourth position 424. At fourth position 424, the camera may capture an image traced by rays 426. This image may contain both a first class of feature (e.g., license plate) and second class of feature (e.g., taillights). Thus, robotic system 402 may move in a straight line parallel to the second side of vehicle 404 towards a fifth position 428. In this example, the fifth position 428 is located past the rear taillight on the passenger's side of vehicle 404. Here, the camera may capture an image containing only a feature in the second class of features 412 (e.g., rear, passenger's side taillight), traced by rays 430. Because the time since last rotation is greater than the predefined amount of time, robotic system 402 may rotate such that the camera now faces a third side of vehicle 404 (e.g., passenger's side of vehicle 404), as shown in FIG. 4C.

FIG. 4C shows a schematic of movements of robotic system 402 along a third side of vehicle 404. After robotic system 402 rotates at fifth position 428, the camera may capture an image of the third side the vehicle. This image may capture a portion of vehicle 404 traced by rays 432 and contain only a feature in the second class of features 412 (rear, passenger's side taillight). Because the robotic agent has just rotated, the time since last rotation is less than the predefined amount of time, and the robotic system will move parallel the third side of vehicle 404 in the −X direction. As the robotic agent moves in the −X direction, the camera may start to capture images containing at least a feature in the first class of features 410. For example, at sixth position 434 the camera can capture an image traced by rays 435 that contains a first class of features (e.g., side windows), and the robotic system may continue to move in the −X direction parallel to the third side of the vehicle. Once the robotic system reaches seventh position 435, the camera may capture an image of vehicle 404 traced by rays 436. This image may only contain second class of feature 412 and robotic system 402 may rotate counter-clockwise to face a fourth side of vehicle 404 (e.g., front side), as shown in FIG. 4D.

FIG. 4D shows a schematic of movements of robotic system 402 along a fourth side of vehicle 404, according to some embodiments. At seventh position 435, the camera may capture an image traced by rays 438. This image may only contain a feature in the second class of features 412 (e.g., front, passenger's side headlight). However, the time since last rotation is less than the predefined amount of time and the robotic system may move parallel to the fourth side of vehicle 404 in the -Y direction. As the robotic system moves towards the center of the fourth side, images captured by the camera may contain at least a feature in the first class of features 410 (e.g., front license plate, front windshield). The robotic system may continue to move in a straight line until the robotic system returns to first position 406 and captures an image traced by rays 440.

Robotic system 402 may stop capturing images once the robotic system returns to its starting position (i.e., first position 406) and/or starting orientation (e.g., rotated to face the front, driver's side headlight). In some embodiments, robotic system 402 may contain a GPS that alerts the system when it has returned to the starting position. In other embodiments, the robotic system may be configured to stop after a certain number of rotations (i.e. 4 rotations).

In some embodiments, as robotic system 402 moves around vehicle 404, a distance sensor may measure the distance between robotic system 402 and object 404. The distance sensor may send distance measurements to the processor, which then determines and sends additional movement instructions to the robotic agent to ensure that robotic system 402 stays approximately a distance D from object 404.

In some embodiments, the robotic system may receive alternate initialization instructions. For example, a time since last rotation may not be set to zero at initialization. In this situation, the robotic system may initially rotate if placed near a corner of an object where only a feature in the second class of features is present. A robotic system may also be initialized at a location near the middle of a side of an object (e.g., second position 414, etc.).

It may be understood by a person of ordinary skill in the art that images may be captured at positions other than those shown in FIGS. 4A-4D. For example, a robotic system may constantly capture video as it moves around an object. Or, a camera in a robotic system may be configured to capture images at predefined intervals (e.g., 30 frames per second, 60 frames per second, etc.).

In another example, shown in FIG. 4E, a robotic system 442 may comprise an aerial robotic agent (e.g., unmanned aerial vehicle, drone, etc.), a camera, one or more distance sensors, and a processor. An unmanned aerial vehicle may capture additional images, for example of the top of the vehicle, which a ground robot cannot capture. Furthermore, an unmanned aerial vehicle may not be subject to uneven ground or ground based obstacles.

Robotic system 442 may travel around vehicle 404 in a manner similar to that of robotic system 402. For example, robotic system 442 may be initialized at a first position 444, and capture images as it moves along the first side of vehicle 404, towards a second position 446, and then towards a third position 448 (e.g., past the back driver's side corner of vehicle 404). Next, robotic system 442 can rotate and capture images of the second and third sides of vehicle 404 following a sequence similar to those described in reference to FIGS. 4B-4D. Image capture positions of robotic system 442 may be located a distance D away from vehicle 404 and a height H above the ground. Although the path of the robotic system as described in FIGS. 4A-4D is a quadrangle, the robotic system 442 may travel in a circular or an elliptical path around the object to capture a 360° image of the object.

In some embodiments, a barometric pressure sensor or altimeter may be used to measure robotic system 442's height H above the ground. A distance sensor attached to or integrated into robotic system 442 may measure the distance D between robotic system 442 and vehicle 404. The processor may send additional movement instructions to ensure that the robotic system 442 maintains an approximate distance D and height H throughout an image capture sequence.

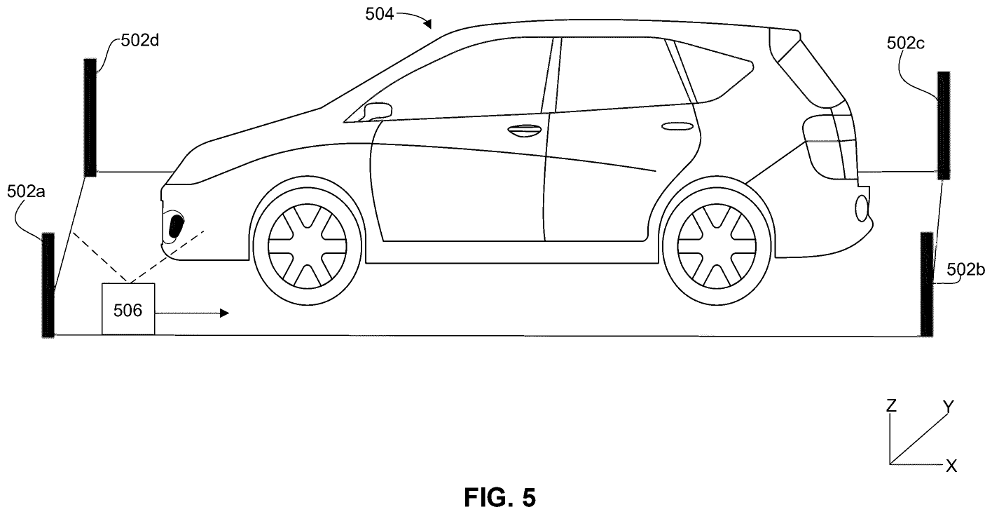

FIG. 5 shows an environment for capturing 360° images of an object, according to some embodiments. The system and method described in FIG. 5 may show an alternative embodiment to the image capture methods described in FIGS. 2, 3, and 4A-4E. In FIG. 5, poles 502 may be placed near each corner of a vehicle 504. A robotic system 506 may be configured to move around vehicle 504, using poles 502 as guides. For example, a user may initialize robotic system 506 near first pole 502a. A processor in the robotic system may instruct the robotic system to move in the +X direction towards a second pole 502b. Once the robotic system reaches second pole 502b, the processor may instruct the robotic system to rotate, and move towards third pole 502c. This process may be repeated the remaining poles (e.g., pole 502d) until robotic system 506 returns to its starting position at first pole 502a. While four poles are shown in FIG. 5, it may understood by a person of ordinary skill in the art that any number of poles 502 may be placed around an object.

In some aspects, robotic system 506 contains a camera. The camera may capture a video or series of images of vehicle 504 as the robotic system moves around the vehicle. In some embodiments, the camera may pan, zoom, and/or tilt such that the camera may capture images of vehicle 504 in a variety of ways (e.g., zoom depths, angles, etc.).

In some aspects, robotic system 506 contains a sensor (e.g., a camera, a LiDAR sensor, etc.) that helps the robotic system navigate between poles 502. For example, if robotic system 506 rotates to avoid an obstacle, the processor may use data from the sensor to direct movement of the robotic system back towards one of the poles 502.

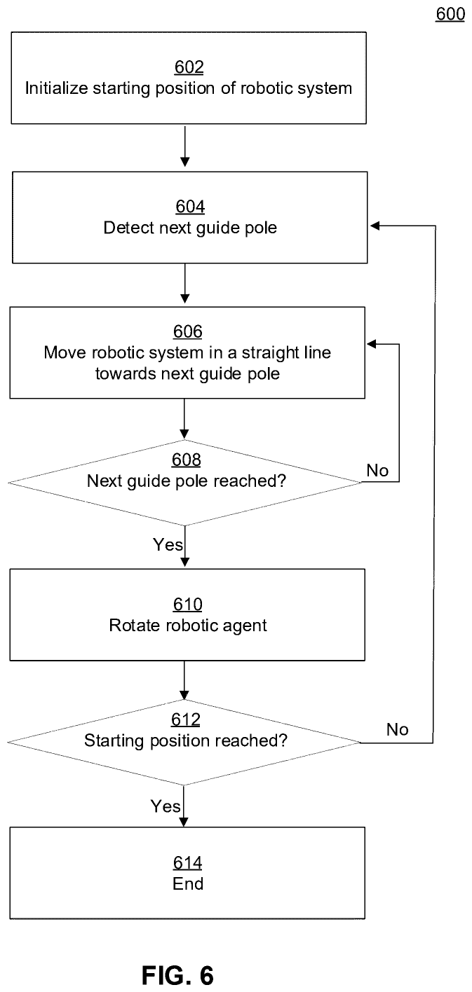

FIG. 6 shows a flowchart of a process 600 for capturing 360° images of an object, such as a vehicle, according to some embodiments. Process 600 may outline movement instructions for a robotic agent configured to move between guide poles, as described in FIG. 5. It may be appreciated that not all steps may be needed to perform the disclosure provided herein. Furthermore, some of the steps may be performed simultaneously, or in a different order than the one shown in FIG. 6, as will be understood by a person of ordinary skill in the art. Process 600 is described with respect to a robotic system containing a robotic agent, a processor, and one or more sensors (e.g., camera, LiDAR, etc.). The steps of process 600 may be implemented by one or more computer systems, such as computer system 800 described in FIG. 8. The process 600 can also be implemented as instructions stored on a machine-readable medium, which can be read and executed by one or more processors.

At step 602, a user may initialize a starting position of the robotic system. The starting position may be located near a guide pole. The robotic system may be positioned such that a camera in the robotic system is facing an object to be captured.

At step 604, a sensor in the robotic system may detect the next guide pole. The sensor may comprise a second camera, a LiDAR sensor, or the like.

At step 606, the processor may send movement instructions to the robotic agent. The movement instructions may comprise moving the robotic agent in a straight line towards the next guide pole, and parallel to a side of the object.

In some aspects, the movement instructions may instruct the robotic agent to move a predetermined distance. For example, if the object has a length L and the posts are located a distance d away from the object, the robotic agent may travel a distance of 2d+L.

At step 608, the processor may determine if the robotic system has reached the next guide pole. This may be accomplished by sensing the distance between the robotic system and the guide pole, or by tracking the distance traveled by the robotic system. If the next guide pole has not been reached, the process returns to step 606. Otherwise, the process continues to step 610.

At step 610, the processor may instruct the robotic agent to rotate. The angle of rotation may be fixed, for example, 90°, or the robotic agent may rotate until the next guide pole is detected.

At step 612, the processor may determine if the robotic system has returned to its starting position. If the robotic system has returned to its starting position, process 600 may end at step 614. If the robotic agent has not returned to its starting position, steps 604-610 may be repeated.

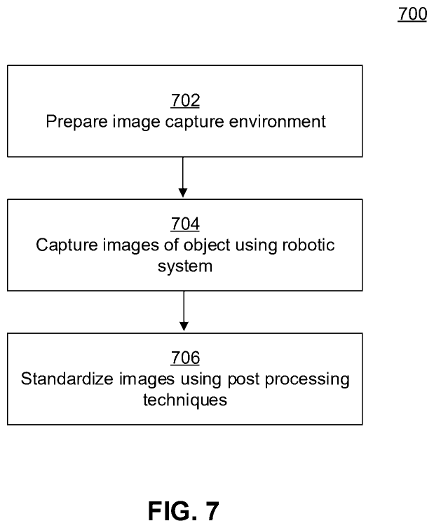

FIG. 7 shows a flowchart of a process 700, according to some aspects. Process 700 may add more detail to process 200 described in FIG. 2. It may be appreciated that not all steps may be needed to perform the disclosure provided herein. Furthermore, some of the steps can be performed simultaneously, or in a different order than the one shown in FIG. 7, as will be understood by a person of ordinary skill in the art. The steps of process 700 may be implemented by one or more computer systems, such as computer system 800 described in FIG. 8. The process 700 can also be implemented as instructions stored on a machine-readable medium, which can be read and executed by one or more processors.

At step 702, a user may prepare an image capture environment. This may include removing obstacles from an environment and/or ensuring that lighting in the environment is sufficient. A vehicle, or other object, may be positioned in the image capture environment.

At step 704, a camera in a robotic system may capture images of the object. The robotic system may move in a 360° path around the object, as described in reference to FIGS. 2-6. For example, a robotic system may be initialized in a starting position. The robotic agent can receive movement instructions that instruct the robotic agent to move around the object. The movement instructions may be determined based on classes of features present in images captured by a camera as the robotic system moves.

At step 706, a processor may standardize the images captured by the robotic system at step 704. Standardization may include post-processing techniques, such as image cropping and background removal. When a video is taken of an object, post-processing can comprise extracting frames of the video. In some embodiments, when frames are used to render a 3D model of an object or monitor changes in an object a large number of frames per second (e.g., about 30 frames per second or about 60 frames per second) may be extracted. In other embodiments, when frames are extracted for display on a website, for example, frame can be extracted from the video at a rate of about one frame per second. Once extracted, the frames may be further processed, for example, the images may be cropped or color corrected, or the background may be removed. The background may be removed using a Segment Everything Model (SAM), or the like.

In some embodiments, post-processing can include choosing a subset of images to display on a website. This may be performed automatically, for example, by sampling images at predefined intervals, or manually by a user.

In some embodiments, a series of captured images are stitched together to form a 3D model of the object. This can be accomplished using volume rendering techniques, such as Instant Neural Graphics Primitives, Gaussian Splatting, Neural Angelo, and the like.

FIG. 8 depicts an example computer system useful for implementing various embodiments.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for capturing a 360 degree image of an object by a robotic system, the method comprising:
capturing, by a camera of the robotic system, a first image of an object at a first location;
identifying, by a processor of the robotic system, whether one or more features are present in the first image of the object using an object detection model;
in response to determining that at least one feature of the one or more features are present in the first image of the object, instructing, by the processor, a robotic agent to move based on a class of the at least one feature that is present in the first image; and
capturing, by the camera, a second image of the object at a second location.

2. The method of claim 1, further comprising determining a distance between the robotic agent and the object using a distance sensor.

3. The method of claim 1, wherein the instructing comprises moving the robotic agent in a line parallel to the object when at least a first class of the one or more features is identified.

4. The method of claim 1, wherein the instructing comprises rotating the robotic agent by 90° when only a second class of the one or more features is identified.

5. The method of claim 4, wherein the instructing comprises restricting the robotic agent from rotating a subsequent time until a predefined amount of time has elapsed.

6. The method of claim 1, wherein the robotic agent comprises a ground robot or an unmanned aerial system.

7. The method of claim 1, wherein the object is a vehicle.

8. A robotic system comprising:
a robotic agent;
a distance sensor coupled the robotic agent;
a camera coupled to the robotic agent; and
a processor configured to:
receive a first image of an object at a first location captured by the camera;
determine, using an object detection model, whether one or more features are present in the first image of the object;
in response to determining that at least one of the one or more features is present in the first image, instructing the robotic agent to move based on a class of the at least one feature that is present in the first image; and
receive a second image of the object at a second location captured by the camera.

9. The robotic system of claim 8, the instructing comprising moving the robotic agent in a line parallel to the object when at least a first class of the one or more features is identified.

10. The robotic system of claim 8, the instructing comprising rotating the robotic agent by 90° when only a second class of the one or more features is identified.

11. The robotic system of claim 10, the instructing comprising restricting the robotic agent from rotating a subsequent time until a predefined amount of time has elapsed.

12. The robotic system of claim 8, the processor further configured to determine a distance between the robotic agent and the object using a distance sensor.

13. The robotic system of claim 8, the robotic agent comprising a ground robot or an unmanned aerial system.

14. The robotic system of claim 8, wherein the object is a vehicle.

15. A non-transitory computer readable medium having instructions stored thereon, that when executed by at least one computing device, cause the at least one computing device to perform operations comprising:
receiving a first image of an object captured by a camera in a robotic system;
determining, using an object detection model, whether one or more features are present in the first image;
in response to determining that at least one feature of the one or more features are present in the first image of the object, instructing a robotic agent to move based on a classification the at least one feature that is present in the first image
capturing, by the camera, a second image of the object at a second location.

16. The non-transitory computer readable medium of claim 15, the operations further comprising determining a distance between the robotic agent and the object using a distance sensor.

17. The non-transitory computer readable medium of claim 15, wherein the instructing comprises moving the robotic agent in a line parallel to the object when at least first class of a feature is identified.

18. The non-transitory computer readable medium of claim 15, wherein the instructing comprises rotating the robotic agent by 90° when only a second class of a feature is identified.

19. The non-transitory computer readable medium of claim 18, wherein the instructing additionally comprise restricting the robotic agent from rotating a subsequent time until a predefined amount of time has elapsed.

20. The non-transitory computer readable medium of claim 15, wherein the object is a vehicle.
